(19) United States
(12) Patent Application Publication
(10) Pub. No.: US 2015/0068972 A1
(43) Pub. Date: Mar. 12, 2015

(54) NANOCOMPOSITE MEMBRANES

(71) Applicant: TAWFIK ABDO SALEH AWADH, Dhahran (SA)

(72) Inventor: TAWFIK ABDO SALEH AWADH, Dhahran (SA)

(73) Assignee: KING FAHD UNIVERSITY OF PETROLEUM AND MINERALS, Dhahran (SA)

(21) Appl. No.: 14/540,271

(22) Filed: Nov. 13, 2014

Related U.S. Application Data
(62) Division of application No. 13/180,266, filed on Jul. 11, 2011.

(51) Int. Cl. C02F 1/44; B01D 71/02; B01D 71/60; B01D 69/12

(52) U.S. Cl. CPC C02F 1/441; B01D 69/12; B01D 71/021; B01D 71/024; B01D 71/60; B01D 2325/10
USPC 210/500.25

(57) ABSTRACT

The nanocomposite membrane includes a composite of carbon nanotubes coated or chemically bonded with metal oxide nanoparticles. This composite is embedded within a polymeric matrix via interfacial polymerization on a polysulfone support. The metal oxide particles are selected to exhibit catalytic activity when filtering pollutants from water in a water treatment system, or for separating a gas from a liquid, or for selectively separating particles or ions from solution for reverse osmosis (e.g., for desalination systems), or other filtration requirements. A method of fabricating the nanocomposite membrane is also included herein.

### CROSS REFERENCE TO RELATED APPLICATIONS

This application is a divisional application of U.S. application Ser. No. 13/180,266, filed Jul. 11, 2011, now pending.

### BACKGROUND OF THE INVENTION

1. Field of the Invention

The present invention relates to membranes, and particularly to a nanocomposite membranes, which are materials having nanoparticles of a metal or metal oxide functionalized on carbon nanotubes embedded in a polymer matrix. The materials are used for filtration of water, separation of gas, solvent, salts from liquid or gas media. The materials can also be used in preconcentration systems for determination process.

2. Description of the Related Art

The demand for fresh water is rapidly approaching the available supply of drinking water. Arid regions or areas far from a ready source are especially affected because they suffer from their ability, finances and resources to meet these demands. To counteract this issue, inroads into purification of nontraditional water sources have been made. One solution for purifying nontraditional water sources involves the use of commercially available reverse osmosis membranes or nanofiltration membranes. Membranes for water treatment usually include polyamide that exhibits good properties of chemical stability and mechanical strength. More recent developments for membranes include a nanocomposite polymeric membrane.

Carbon nanotubes (CNTs) have been used to fabricate nanocomposite polymeric membranes with certain mechanical and thermal properties. Many studies indicate that CNTs/polymer composites are only slightly stronger than the neat polymers. While such studies suggest that CNTs/polymer composites exhibit mechanical properties on par or greater than neat polymers, it does not appear that significant filtration increases have been found.

In light of the above, it would be a benefit in the art of filtration systems to provide membranes with more efficient filtration capabilities. Thus, a nanocomposite membrane solving the aforementioned problems is desired.

### SUMMARY OF THE INVENTION

The nanocomposite membrane includes a composite of carbon nanotubes coated or chemically bonded with metal oxide nanoparticles. This composite is embedded within a polymeric matrix via interfacial polymerization on a polysulfone support. The metal oxide particles are selected to exhibit catalytic activity when filtering pollutants from water in a water treatment system, or for separating a gas from a liquid, or for selectively separating particles or ions from solution for reverse osmosis (e.g., for desalination systems), or other filtration requirements. A method of fabricating the nanocomposite membrane is also included herein.

These and other features of the present invention will become readily apparent upon further review of the following specification and drawings.

### BRIEF DESCRIPTION OF THE DRAWINGS

FIG. 1 is a schematic diagram of a nanocomposite membrane according to the present invention.

FIG. 2 is a schematic diagram of the steps for making a nanocomposite membrane according to the present invention.

FIG. 3 is a scanning electron micrograph of the nanocomposite of CNT functionalized with titanium dioxide nanoparticles.

Similar reference characters denote corresponding features consistently throughout the attached drawings.

### DETAILED DESCRIPTION OF THE PREFERRED EMBODIMENTS

The nanocomposite membrane, generally referred to by the reference number 10 in the drawings, includes chemical, mechanical and thermodynamic properties for improved filtration performance. Moreover, the process for making the nanocomposite membrane provides a platform where various types of nanoparticles may be embedded on CNTs to produce polymeric nanocomposites with widely varying structure, morphology, charge, hydrophilicity, and thus rejection and permeability. This expands the capabilities of the membrane by having organic functionalized with inorganic components that have diverse activities for applications in reverse osmosis, nanofiltration and preconcentration.

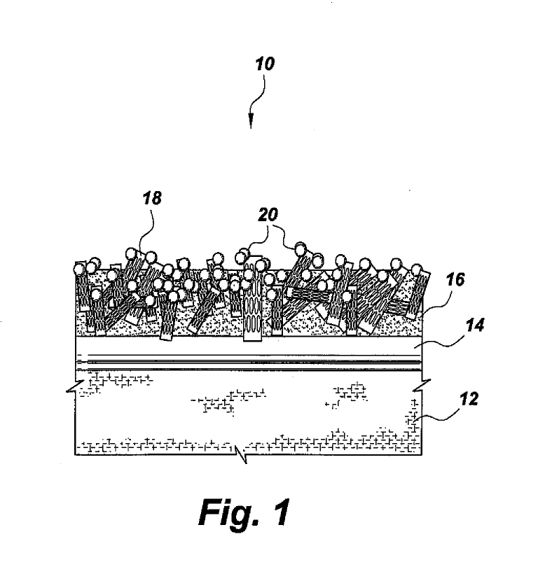

With reference to the schematic diagram shown in FIG. 1, the following describes a nanocomposite membrane 10 and the method of making the nanocomposite membrane. In this exemplary embodiment, the nanocomposite membrane 10 includes a substrate or support 12 with a polymeric matrix bonded thereon. The polymeric matrix includes a layer of first monomer 14 and an overlying layer of a second monomer 14. A composite of carbon nanotubes (CNT) 18 functionalized with metal or metal oxide nanoparticles 20 is embedded in the polymeric matrix on a porous polysulfone support to form the membrane 10.

To fabricate the nanocomposite membrane or membrane 10, the composite begins with the CNT 18 functionalized with the nanoparticles 20. Surface functionalization of CNTs 18 is the initial step for activating CNTs 18 by creating sufficient binding sites for attaching the metal or metal oxide nanoparticles, or their precursors. Surface modification of CNTs 18 is generally carried out by oxidation treatment with an oxidizing agent for an optimum period of time and temperature. The oxidizing agent can be any oxidizing agent, such as nitric acid, mixtures of sulfuric acid and nitric acid, potassium permanganate, hydrogen peroxide, etc. The optimum reflux time depends on the amount of sites that are required. Thus, the reflux time can be between approximately one minute and 48 hours. More time can be used if more binding sites are required. The optimum reflux temperature can be between room temperature and 200° C. Some examples of the binding sites include carbonyl and carboxyl groups. The CNTs 18 can be single-walled carbon nanotubes, double-walled carbon nanotubes, multi-walled carbon nanotubes, or a combination thereof.

Characterization of the surface of the CNTs 18 can ensure the formation of the binding sites. Characterization may be facilitated by different characterization techniques, such as X-ray diffraction (XRD), field emission scanning electron microscope (FESEM) and high resolution transmission electron microscopy (HRTEM), Fourier transform infrared absorption spectroscopy (FTIR), X-ray photoelectron spectroscopy (XPS) and UV-vis spectrometry.

Examples of the results are as follows. XRD pattern of the oxidized CNTs 18 shows sharp and intense peaks at 2θ=25.9° corresponds to the (002), and diffraction peaks at 2θ of 42.6°, 43.5°, 53.3° and 77.4° which are indexed to the (100), (101), (004) and (110) planes. FTIR reveals the bands at around 1710 m⁻¹, 1670 m⁻¹, 1562 cm⁻¹, 1200 cm⁻¹, 3450 cm⁻¹ ascribed to C═O stretching vibration, unsaturated structural of C═C, vibration of C—O bonds, and to stretching vibrations of OH or OH in carboxyl groups. This proves the activation of CNTs 18 by formation of binding sites as carbonyl and carboxyl groups on the surface of the CNTs 18.

Different methods can be used to prepare CNT/metal or CNT/metal oxide nanocomposites. Initially, the nanoparticles 20 can be prepared and then coated, embedded or bonded to CNT 18. As an alternative, nanoparticles 20 can be prepared and embedded to CNT 18 in one step. An example is a wet chemistry, modified sol-gel method, which is simple and cost effective. The nanoparticles 20 can be metal and metal oxide nanoparticles or a combination thereof. The metal nanoparticles can be of any metal for a specific purpose. For example, silver nanoparticles can be embedded onto CNTs 18 to increase antibiofouling functions, which promotes increased efficiency of the membranes. Another example includes titania nanoparticles embedded onto the CNTs 18. The resultant membrane exhibits different properties, such as photocatalytic property, self-cleaning, and decreased fouling. These types of properties increase the lifetime of the membranes and increase hydrophilicity on the surface of the membrane.

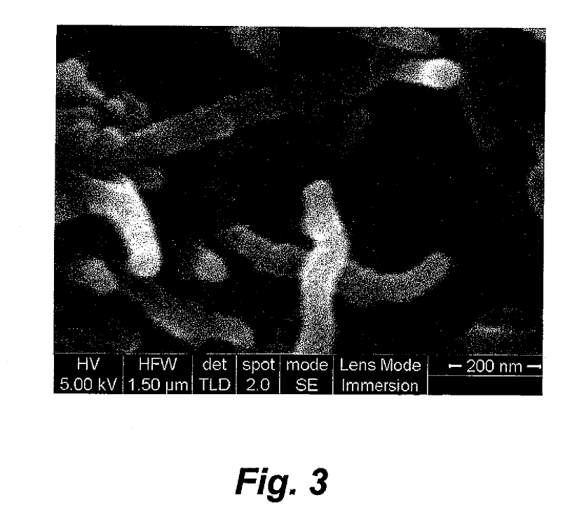

After preparation, the CNT-based nanocomposites are characterized. Characterization techniques such as X-ray diffraction (XRD), field emission scanning electron microscope (FESEM) and high resolution transmission electron microscopy (HRTEM), Fourier transform infrared absorption spectroscopy (FTIR), X-ray photoelectron spectroscopy (XPS) and UV-vis spectrometry are used to gather data on the formation of the nanocomposites. An example of a nanocomposite of CNT functionalized with titanium dioxide nanoparticles is shown in FIG. 3. The results of the characterization provide indicators and other data on the progress and success of nanocomposite formation. For example, TEM images of CNT/metal or metal oxide composite clearly illustrate the loading of the nanoparticles on the surface of CNTs. The percentage of metal or metal oxides nanoparticles on the surface of CNTs is informed by energy-dispersive X-ray spectroscopic measurements. XRD pattern of the composites can give indication of the phases of the composites. FTIR of the composites can give indication of the functional groups. For example, the shift toward higher wavenumber of the metal-oxide covalent bond confirms the existence of a close interaction between metal oxide and CNTs 18 and thus the formation of the ionic chemical bond between CNTs 18 and metal or metal oxide through the carboxylate. The shift in the band assigned to C═O stretching vibration toward lower wavenumber is also a similar indicator.

Once the CNT/metal or CNT/metal oxide nanoparticles are prepared, they can be embedded into polymeric membrane via a polymerization process. The polymerization process can be any polymerization process through which nanocomposite can be embedded into the polymeric membrane, such as interfacial polymerization of two or more monomers. Monomers can be any monomers that are immiscible. Examples of the first monomer 14 are aromatic diamines and of the second monomer 16 are aromatic diacide, triacide or poly-acid halides. The first monomer can be dissolved in aqueous phase while the second monomer is dissolved in non-polar phase. One such method includes a type of interfacial polymerization for synthesis of the membrane.

The modified interfacial polymerization process is facilitated by polymerizing two monomers or polymerizable species on the support or substrate 12. The two monomers are in different liquid media. The nanocomposite can be dispersed in any of the monomers media. The support 12 is taped to a plate, such as glass plate, and then immersed in a liquid of the first monomer 14 for a suitable period of time. Then the excess solution is removed from the support surface. The completion of this process is followed by immersing the support into a solution of the second monomer for an appropriate time until the composite of CNT/nanoparticles is well dispersed into the second monomer 16.

The support 10 can be any polymer that is resistant to oxidizing agents, surfactants, oils, acids, alkali, and electrolytes in a wide range of pH. The support 10 should also exhibit high mechanical and compaction resistance, especially for use under high pressures. Examples of the support are polysulfone, polyethersulfone, polyester, and materials of similar properties.

The invention is described in the following example in which a membrane of CNT/TiO₂-polyamide is prepared according to the invention.

### EXAMPLE

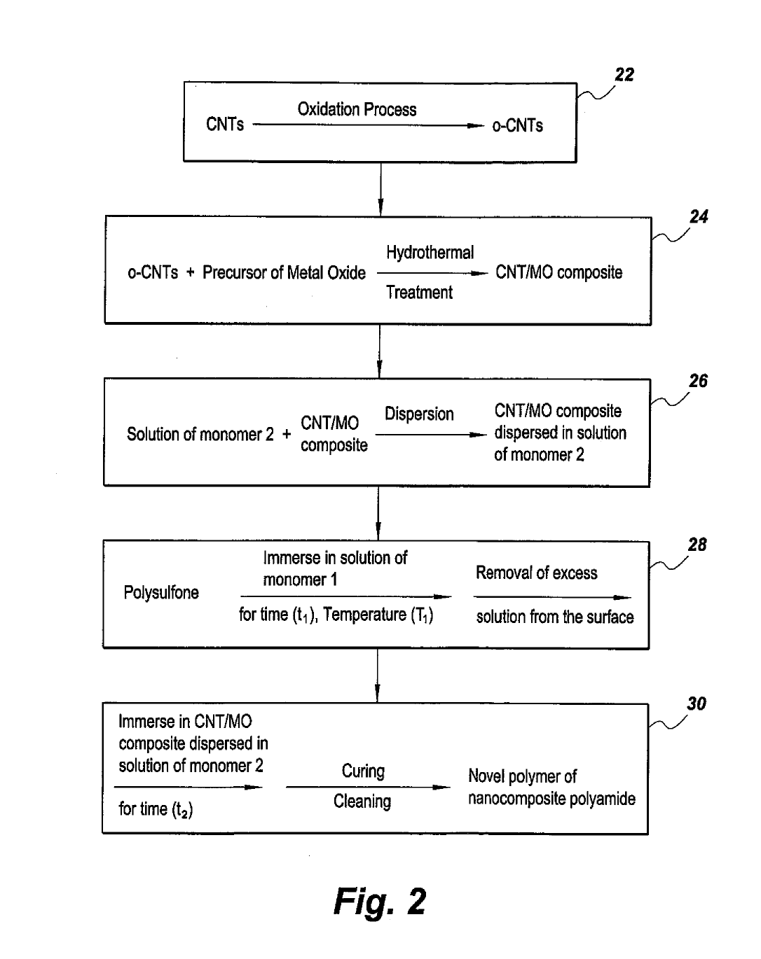

In reference to FIG. 2, the activation and functionalization of CNTs 18 are prepared in the manner described above, as indicated by step 22. The next step 24 is the preparation of CNT/TiO₂. Titanium (IV) n-butoxide (TNB) is dissolved in 50 ml ethanol. Activated CNTs 18 are dispersed in ethanol inside a separate container by sonication. Then the dispersed CNTs 18 are added into the TNB solution while being stirred. This is followed by sonication until a gel is formed. The gel is aged for 24 hours. The mixture is then dried, and the powder is calcined at 300° C. for 3 hours. The formed composite is ground and then characterized as mentioned in the previous sections.

The as-synthesized CNT/TiO₂ nanocomposite 18, 20 was used for the formation of the membrane. In step 26, CNT/TiO₂ nanocomposite 18, 20 was dispersed in a solution of trimesoyl chloride in n-hexane. In step 28, a support or substrate 12 of polysulfone was taped to a plate. A non-limiting example of the plate is a one made from glass. Then the plate was immersed into an aqueous solution of m-phenylenediamine for a predetermined period of time. At the end of this period, the plate was taken out from the solution and the excess solution removed. In step 30, the plate was placed in a non-polar solution of the trimesoyl chloride in which CNT/TiO₂ nanocomposite 18, 20 has been dispersed. The plate was kept in the trimesoyl chloride solution for a predetermined period of time to produce a thin layer of aromatic polyamide embedded with nanocomposite via modified interfacial polymerization. The resulting membrane was cured in an oven at about 80° C. for a predetermined period of time. The membrane 10 is characterized as mentioned in the previous sections. Then the membrane 10 was tested for rejection of some salts. The results show high rejection and excellent permeation flux.

It is to be understood that the present invention is not limited to the embodiments described above, but encompasses any and all embodiments within the scope of the following claims.

1-10. (canceled)

11. A nanocomposite membrane, comprising:
a porous support;
a nanocomposite having carbon nanotubes functionalized with nanoparticles of a metal or metal oxide; and
a polymer thin film formed on the support, the nanocomposite being embedded in the polymer thin film.

12. The nanocomposite membrane according to claim 11, wherein the thin film comprises a first monomer and a second monomer polymerized by interfacial polymerization, the first monomer comprising aromatic diamines.

13. The nanocomposite membrane according to claim 11, wherein said second monomer is selected from a group consisting of diacide, triacide and poly-acid halides.
